(19) United States
(12) Patent Application Publication
(10) Pub. No.: US 2007/0122068 A1
(43) Pub. Date: May 31, 2007

(54) Friction bearing

(76) Inventors: Rainer Aufischer, Oberweis (AT); Hubert Lang, Au an der Donau (AT)

Correspondence Address: WILLIAM COLLARD;COLLARD & ROE, P.C., 1077 NORTHERN BOULEVARD, ROSLYN, NY, 11576, US

(21) Appl. No.: 10/582,560

(22) PCT Filed: Dec. 17, 2004
(86) PCT No.: PCT/AT04/00446

§ 371 Date: Jun. 12, 2006

(30) Foreign Application Priority Data
Dec. 17, 2003 (AT) A 2032/2003

(51) Int. Cl. F16C 33/02

(52) U.S. Cl. 384/280

(57) ABSTRACT

A friction bearing is described, comprising a support shell and a slide layer made of a bearing metal which is applied to the support shell. In order to obtain information about the service life of the friction bearing it is proposed that the slide layer carries a cover layer forming a running layer whose thickness corresponds at most to the wear and tear of the cover layer expected during the average service life of the slide layer.

### FIELD OF THE INVENTION

The invention relates to a friction bearing with a support shell and a slide layer made of a bearing metal which is applied to the support shell.

### DESCRIPTION OF THE PRIOR ART

In the case of dual-material bearings which consist of a support shell and a slide layer which is applied to the support shell and is made of a bearing metal such as an aluminium-tin alloy for example, the service life is determined by the fatigue strength of the bearing metal of the slide layer which is subjected to a bending fatigue stress. Such a friction bearing should be exchanged prior to the occurrence of a breakage of the bearing metal. Since the remaining service life cannot be detected in the friction bearing per se, there are considerable problems in practice in determining the remaining service life, since the service life depends not only on the working time but also on the loading of the respective friction bearing.

### SUMMARY OF THE INVENTION

The invention is thus based on the object of providing a friction bearing of the kind mentioned above in such a way that a necessary change of bearing can be recognized in the bearing per se owing to the likelihood of a breakage of the bearing metal.

This object is achieved by the invention in such a way that the slide layer carries a cover layer forming a running layer whose thickness corresponds at most to the wear and tear of the cover layer expected during the average service life of the slide layer.

The invention is based on the finding that the wear and tear of a cover layer forming a running layer for the friction bearing depends both on the working time of the bearing as well as on its loading, so that the wearing of the cover layer can be determined for a predetermined average bearing load and a standard service life of the bearing based on such average bearing load. If therefore a cover layer which differs from the slide layer is applied in a thickness which corresponds at most to the wear and tear of the cover layer expected during the average working time of the slide layer, an impending change of bearing can be recognized by the wear and tear of the cover layer. Especially simple conditions concerning the determination of a necessary change of bearing are obtained when the cover layer forming the running layer differs optically from the slide layer, because in this case the necessity for a change of bearing can be recognized by merely glancing at the bearing, such that the change of the running surface changes according to wear and tear of the running layer. Although it is known in friction bearings with a slide layer made of a bearing metal on the basis of aluminium to apply several layers of differently coloured polyamide to the slide layer in order to evaluate the locally differing stresses on the bearing on the basis of the colour pattern obtained over the running surface once the bearing has been run in. The optical recognition of the locally differing bearing stresses does not provide any direct conclusion on the service life of the bearing.

Although all cover layers which are suitable for forming the running surface and offer a respective wear and tear over the service life of the friction bearing can be used in accordance with the invention, especially advantageous constructional conditions are obtained when the cover layer consists of a sliding lacquer whose wear and tear is substantially independent of the applied layer thickness, so that with the help of such a sliding lacquer an adjustment to very different service lives will become possible. These sliding lacquers can also have a coloring which clearly differs from the bearing metal of the slide layer, which is highly relevant for the evaluation of the residual service life of a friction bearing. Sliding lacquers on the basis of graphite or molybdenum sulfide having a black coloring are especially advantageously suitable for this kind of application.

### BRIEF DESCRIPTION OF THE DRAWINGS

The invention is now explained in closer detail by reference to the enclosed drawings, wherein:

FIG. 1 shows the dependence of the service life of a dual-material friction bearing on the average load in a characteristic curve which illustrates the number of load changes until bearing metal breakage under different loads, and

FIG. 2 shows the wear and tear of a cover layer made of a sliding lacquer based on molybdenum sulfide on the basis of characteristic lines representative of the wear-induced decrease of thickness of the cover layer over the load time of a predetermined load.

### DESCRIPTION OF THE PREFERRED EMBODIMENT

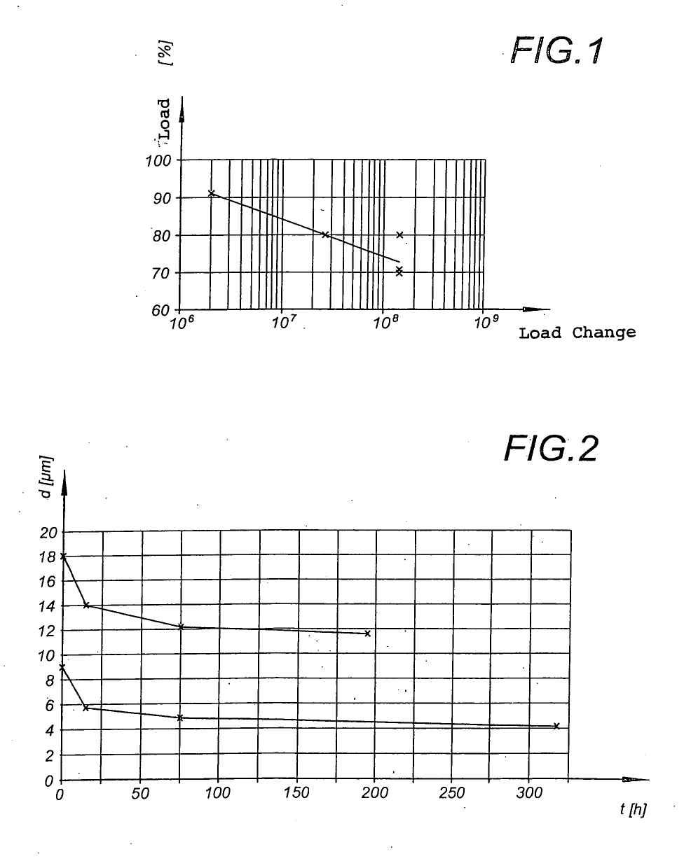

In order to show the dependence of the service life of a dual-material bearing on the average load, respective tests were carried out on a bearing testing machine under increased loads for determining the result under reduced time conditions. As can be seen in FIG. 1 in which the bearing load has been entered on the ordinate in percent of maximum load and in which the number of load changes has been entered on the abscissa until the occurrence of a bearing metal breakage on a logarithmic scale, the service life of the examined type of bearing metal with a steel support shell and a slide layer of AlSn20 as the bearing metal increases with falling load and comprises 1.44×10⁸ load changes at a load of 75% of maximum load, which corresponds to a service life of approximately 400 hours.

FIG. 2 shows on the ordinate the thickness d of a cover lacquer on the basis of molybdenum sulfide over the load time t stated on the abscissa in hours h. This occurs under the condition that the loading of the slide lacquer layer corresponded to the friction bearing examined with respect to its service life whose examination results are compiled in FIG. 1. In the case of a dynamic bearing load of 75% of the maximum load, a wear and tear of approximately 5 μm can be determined for a loading time of 190 h at an initial layer thickness of 18 μm. In the case of an initial layer thickness of 9 μm, a wear and tear of approximately 4 μm is obtained after 330 h. The wear and tear is thus substantially independent of the original layer thickness of the running layer, so that the load-dependent service life of the slide bearing can be determined on the basis of wear and tear, not only for different thicknesses of the running layer but also for different bearing metals.

When a cover layer in a thickness of 4 μm is applied in the form of a sliding lacquer onto the slide layer made of the bearing metal AlSn20 for a friction bearing as was examined for the representation according to FIG. 1, the bearing metal exposed after the wear and tear of the cover layer and having a different color as compared with the cover layer indicates the impending end of the service life of the slide layer and thus the necessary change of the bearing. Conventional sliding lacquers consist for example of 80 percent by weight of polyamideimide and 20 percent by weight of polytetrafluor ethylene. These sliding lacquers have a color like the brown color of an egg-shell. In order to achieve a respective contrast with respect to the bearing metal, 77 percent by weight of polyamideimide can be mixed with 20 percent by weight of polytetrafluor ethylene and 3 percent by weight of chromium oxide, leading to a green coloration of the cover layer. If 2 percent by weight of molybdenum sulfide are used instead of the chromium oxide in conjunction with 1 percent by weight of graphite, a black slide layer is obtained without any negative influence on the tribological properties of the sliding lacquer.

1. A friction bearing with a support shell and a slide layer made of a bearing metal which is applied to the support shell, wherein the slide layer carries a cover layer forming a running layer whose thickness corresponds at most to the wear and tear of the cover layer expected during the average service life of the slide layer.

2. A friction bearing according to claim 1, wherein the cover layer forming the running layer differs optically from the slide layer.

3. A friction bearing according to claim 1, wherein the cover layer consists of a sliding lacquer.

4. A friction bearing according to claim 3, wherein the cover layer is covered by a sliding lacquer on the basis of graphite.

5. A friction bearing according to claim 3, wherein the cover layer is covered with a sliding lacquer on the basis of molybdenum sulfide.
